(19) United States
(12) Patent Application Publication
(10) Pub. No.: US 2014/0081910 A1
(43) Pub. Date: Mar. 20, 2014

(54) METHOD AND APPARATUS FOR DOCUMENT UPDATING

(71) Applicant: HUAWEI TECHNOLOGIES CO., LTD., Shenzhen (CN)

(72) Inventors: Kai WANG, Shenzhen (CN); Lei SONG, Shenzhen (CN)

(73) Assignee: HUAWEI TECHNOLOGIES CO., LTD., Shenzhen (CN)

(21) Appl. No.: 14/086,469

(22) Filed: Nov. 21, 2013

Related U.S. Application Data
(63) Continuation of application No. PCT/CN2011/078761, filed on Aug. 23, 2011.

(51) Int. Cl. G06F 17/30

(52) U.S. Cl. CPC G06F 17/3061
USPC 707/609

(57) ABSTRACT

The present disclosure provides a method and an apparatus for document updating. The method includes: obtaining an update document package, where the update document package includes update navigation information and an update file, where each navigation node in the update navigation information is associated with a corresponding update file respectively; and according to the update navigation information and source navigation information of a source document package, integrating the update document package into the source document package to update the source document package, where the source document package includes the source navigation information and a source file, where each navigation node in the source navigation information is associated with a corresponding source file respectively. The embodiments of the present invention may effectively update a document, making of the update file is simple and a making process is convenient, applicable to document management and updating for telecommunication field devices.

### CROSS-REFERENCE TO RELATED APPLICATIONS

This application is a continuation of International Application No. PCT/CN2011/078761, filed on Aug. 23, 2011, which is hereby incorporated by reference in its entirety.

### TECHNICAL FIELD

The present disclosure relates to a document updating technology, and in particular, to a method and an apparatus for document updating.

### BACKGROUND

In the telecommunications field, each device needs to be configured with documents, which may be various description, help, and other files. Because telecommunications field products are rapidly updated and upgraded, correspondingly, documents of each product also need to be updated frequently. How to effectively update documents become important content in document management in the telecommunications field.

At present, one set of telecommunications devices may involve multiple products, versions, network management systems, and network elements, while relating to document maintenance of different products, document coexistence of different versions, document usage of different network management systems, and document dynamic expansion of different network elements and so on. Meanwhile, these documents themselves are relatively large and are usually compiled by different compilers, making document management and updating extremely complicated. In the prior art, documents of one set of telecommunications devices are usually provided in a file format. The documents include various needed document content, and users need to update these documents. For example, when users modify, delete, or extend a document, they need to update the whole document content, such as a current compiled help manual (Compiled Help Manual, CHM), and office series Doc document and Docx document.

Accordingly, when current telecommunications device documents are being updated, full text replacement is needed, making document updating complicated. When the documents are being modified, all the documents need to be processed. Especially when a large number of documents are being processed, updating process is complicated, updating duration is long, and making of an update file is also very difficult.

### SUMMARY

Embodiments of the present invention provide a method and an apparatus for document updating, in order to solve a defect of complicated document updating in the prior art and to improve document updating convenience.

The embodiments of the present invention provide a method for document updating. The method includes:

obtaining an update document package, where the update document package includes update navigation information and an update file, where each navigation node in the update navigation information is associated with a corresponding update file respectively;

according to the update navigation information and source navigation information of a source document package, integrating the update document package into the source document package to update the source document package, where

the source document package includes the update navigation information and a source file, where each navigation node in the update navigation information is associated with a corresponding source file respectively.

The embodiments of the present invention provide an apparatus for document updating. The apparatus includes:

an update document obtaining module, configured to obtain an update document package, where the update document package includes update navigation information and an update file, where each navigation node in the update navigation information is associated with a corresponding update file respectively;

a document updating module, configured to: according to the update navigation information and source navigation information of the source document package, integrate the update document package into a source document package to update the source document package, where

the source document package includes the update navigation information and a source file, where each navigation node in the update navigation information is associated with a corresponding source file respectively.

The method and apparatus for document updating provided in the embodiments of the prevent invention, through making the update document package as a document package containing the navigation information, implement updating of the source document package containing the navigation information by integrating the update document package into the source document package according to the navigation information. During the document updating, the update document package only needs to include the file to be updated; therefore, the update document package is relatively small and the making of an update file is very simple. Meanwhile, during the updating of the source document package, only the file to be updated needs to be integrated into the source document package, making document update process simple and convenient. The method and apparatus especially apply to update processing of a large document and may effectively improve convenience in document updating.

### BRIEF DESCRIPTION OF DRAWINGS

To illustrate the technical solutions in the embodiments of the present invention more clearly, the following briefly introduces the accompanying drawings needed for describing the embodiments. Apparently, the accompanying drawings in the following description merely show some embodiments of the present invention, and persons of ordinary skill in the art may still derive other drawings from these accompanying drawings without creative efforts.

FIG. 1 is a schematic flowchart of a method for document updating provided by Embodiment 1 of the present invention;

FIG. 2 is a schematic flowchart of a method for document updating provided by Embodiment 2 of the present invention;

FIG. 3 is a schematic flowchart of a method for document updating provided by Embodiment 3 of the present invention;

FIG. 4 is a schematic flowchart of a method for document updating provided by Embodiment 4 of the present invention;

FIG. 5 is a schematic structural diagram of an apparatus for document updating provided by Embodiment 5 of the present invention;

FIG. 6 is a schematic structural diagram of an apparatus for document updating by Embodiment 6 of the present invention;

FIG. 7 is a schematic structural diagram of an apparatus for document updating by Embodiment 7 of the present invention; and

FIG. 8 is a schematic structural diagram of an apparatus for document updating by Embodiment 8 of the present invention.

### DESCRIPTION OF EMBODIMENTS

To make the objectives, technical solutions, and advantages of the embodiments of the present invention more clearly, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiment of the present invention without creative efforts shall fall within the protection scope of the present invention.

The technical solutions in the embodiments of the present invention provide a method and an apparatus for document updating. According to the method and apparatus for document updating, documents may be classified into three types: basic document package, patch document package, and extended document package. During document making, the document may be made to one of the following formats as needed: the basic document package and patch document package; the basic document package and extended document package; the basic document package, extended document package, and patch document package. Each type of document package may be composed of multiple files of different formats, including navigation information used for navigation and presentation, where each navigation node in the navigation information is associated with a file used for presentation. In this way, each file is presented according to the navigation information during document presentation. The following illustrates the method for document updating provided by the present invention with specific embodiments.

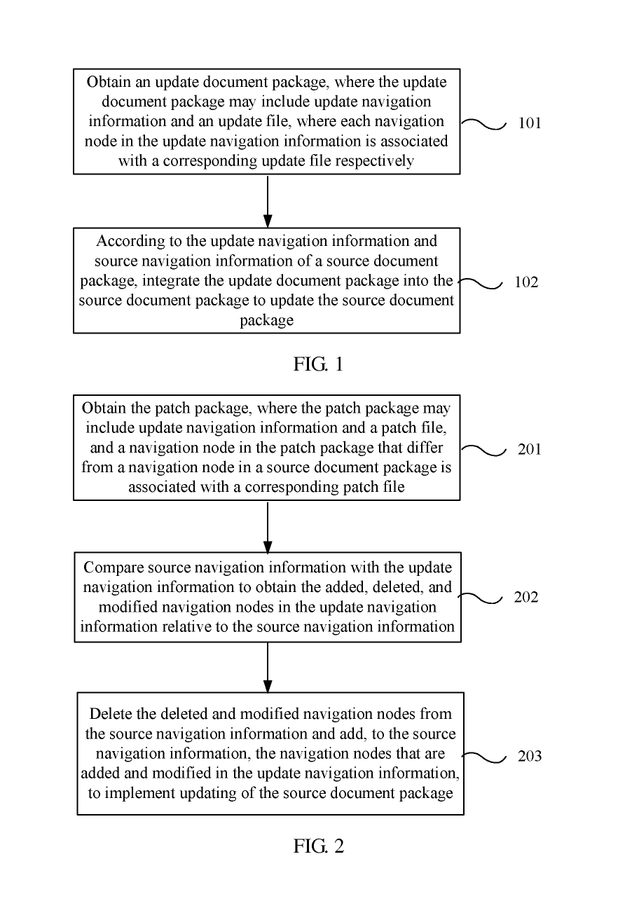

FIG. 1 is a schematic flowchart of a method for document updating provided by Embodiment 1 of the present invention. As shown in FIG. 1, the method includes the following steps:

Step 101: Obtain an update document package, where the update document package may include update navigation information and an update file, where each navigation node in the update navigation information is associated with a corresponding update file respectively.

Step 102: According to the update navigation information and source navigation information of a source document package, integrate the update document package into the source document package to update the source document package, where the source document package may include the source navigation information and a source file, where each navigation node in the source navigation information is associated with a corresponding source file respectively.

This embodiment may be applied to update a document, especially applicable to update a relatively large document that needs to be updated frequently. In this embodiment, the source document package and update document package both exist as an independent document package, and the document package may be made by integrating multiple source files or update files, including navigation information, and a source file or an update file associated with each navigation node in the navigation information. In this way, during the updating of the source document package, for example patch updating or extended updating, the update files may be integrated into the source document package according to the navigation information to update the source document package.

In this embodiment, a file in the source document package may be presented according to the navigation information and users may view a corresponding document file by selecting each navigation node, which makes document viewing convenient. The file associated with each navigation node may be a file compiled in different formats and the file is associated with the navigation node during the making of the document package.

The method for document updating provided in this embodiment, through making the update document package as the document package containing the navigation information, implements updating of the source document package containing the navigation information by integrating the update document package into the source document package according to the navigation information. During document updating, the update document package only needs to include the files to be updated; therefore, the update document package is relatively small and the making of update files is very simple. Meanwhile, during the updating of the source document package, only the files to be updated are required to be combined to the source document package, making document update process simple and convenient. The method especially applies to update processing of a large document and may effectively improve convenience in document updating.

FIG. 2 is a schematic flowchart of a method for document updating provided by Embodiment 2 of the present invention. An update document package in this embodiment is a patch package and the method for document updating in this embodiment may be used to perform patch updating on a basic package or an extended package that functions as a parent package. As shown in FIG. 2, the method for document updating provided by this embodiment may specifically include the following steps:

Step 201: Obtain the patch package, where the patch package may include update navigation information and a patch file, and a navigation node in the patch package that differ from a navigation node in a source document package is associated with a corresponding patch file.

Step 202: Compare source navigation information with the update navigation information to obtain the added, deleted, and modified navigation nodes in the update navigation information relative to the source navigation information.

Step 203: Delete the deleted and modified navigation nodes from the source navigation information and add, to the source navigation information, the navigation nodes that are added and modified in the update navigation information, to implement updating of the source document package.

In this embodiment, the patch package includes a newly added modified patch file only and does not include other unmodified files in the source document package. In this way, during making of the patch package, only a newly added modified patch file and corresponding navigation information need to be made; therefore, the making of the patch package is very simple. Besides, the patch package is relatively small, which facilitates the making and uploading of the patch package, making updating of a document package convenient.

In this embodiment, the source document package is the basic package that functions as the parent package. A person skilled in the art may understand that the source document package may also be the extended package or another patch package.

In this embodiment, the patch package may include patch package information, where the patch package information includes source document package information indicating the source document package that needs to be updated by the patch package. Before document updating is performed, the source document package that needs to be updated may be determined according to the patch package information, so as to perform updating on the determined source document package. In this way, when there are multiple source document packages, the document package that needs to be updated may be updated effectively. In practical applications, the source document package information may specifically include an identifier of the source document package to be updated, that is, a parent package identifier. Therefore, the parent package identifier may be used to determine which document package is to be updated.

In this embodiment, the navigation information of the patch package is the navigation information needs to be included in the parent package after the parent package is updated, and in the patch package only a modified navigation node has associated a patch file and a unmodified navigation node may not be associated with any file. In this way, only a modified navigation node needs to be integrated into a corresponding navigation node in the source document package and a modified navigation node needs to be deleted from the source navigation information during the updating of a source document.

In this embodiment, both the patch package and the parent package carry basic information that identifies a document, for example, the identifier that identifies a document package type. The details are provided in description of composition and making of the document package below. Therefore, the basic information about each document package may be used to determine the type of the document package, the document that needs to be updated, and the document package that is used for updating.

It may be seen that, this embodiment uses the patch package to update the document package and it implements the patch updating on the document. During a patch updating process, the patch package only needs to include a patch file to be modified and does not need to include other files in the source document package; therefore, the making of the patch package is very simple. The patch package is relatively small, which facilitates uploading of the patch package, making updating of the source document package convenient.

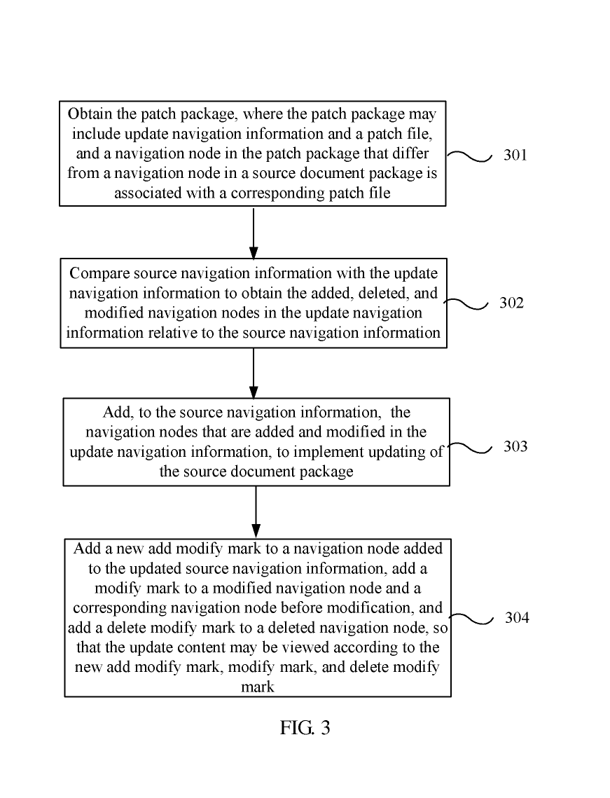

FIG. 3 is a schematic flowchart of a method for document updating provided by Embodiment 3 of the present invention. Different from the embodiment in the foregoing FIG. 2, in this embodiment, update content may be distinguished when a patch package is integrated into a parent package, so that users may conveniently know modifications made to the parent package. As shown in FIG. 3, the method for document updating provided by this embodiment may specifically include the following steps:

Step 301: Obtain the patch package, where the patch package may include update navigation information and a patch file, and a navigation node in the patch package that differ from a navigation node in a source document package is associated with a corresponding patch file.

Step 302: Compare source navigation information with the update navigation information to obtain the added, deleted, and modified navigation nodes in the update navigation information relative to the source navigation information.

Step 303: Add, to the source navigation information, the navigation nodes that are added and modified in the update navigation information, to implement updating of the source document package.

Step 304: Add a new add modify mark to a navigation node added to the updated source navigation information, add a modify mark to a modified navigation node and a corresponding navigation node before modification, and add a delete modify mark to a deleted navigation node, so that the update content may be viewed according to the new add modify mark, modify mark, and delete modify mark.

In this embodiment, when the patch updating is performed on the basic package that functions as the parent package, all the files in the source document package and the patch package may be included in the updated document package and different modify marks may be added to distinguish modifications, so that the update content may be distinguishably displayed according to the modify marks by using colors. For example, the new added navigation node and the corresponding patch file may be displayed in red and the deleted navigation node and its source file may be displayed in gray, and so on. There is no specific limitation on a detailed presentation format so long as users may distinguish the update content.

As it may be seen that, through adding the modify mark to the updated navigation node, users may easily identify the update content and view document content.

FIG. 4 is a schematic flowchart of a method for document updating provided by Embodiment 4 of the present invention. An update document in this embodiment is an extended package and the method for document updating provided in this embodiment may be used to extend a basic package, a patch package or another extended package, which functions as a parent package. The parent package in this embodiment is the basic package. As shown in FIG. 4, the method for document updating provided by this embodiment may specifically include the following steps:

Step 401: Obtain the extended package, where the extended package includes update navigation information and an extended file, the extended package includes destination node information, where each navigation node in the navigation information of the extended package is associated with the extended file that functions as an update file.

Step 402: Search source navigation information for an extended node corresponding to the destination node information according to the destination node information in the extended package.

Step 403: Integrate the update navigation information into a location corresponding to the extended node, and integrate the extended package into a source document package.

This embodiment may update only the parent package that needs to be extended. During updating, the navigation information in the extended package is integrated, according to the destination node information carried in the extended package, into the parent package to be extended, to implement extended updating on the parent package. In this way, when a document is being extended, only a file that needs to be extended needs to be edited to form the extended package, while there is no need to perform editing based on the source document package. Making of the extended package is convenient and it may increase convenience in extending the document package. Meanwhile, it facilitates document management and uploading. Besides, during the making of the extended package, there is no limitation on the format of files in the extended package and files may be compiled in different formats by persons, effectively improving the convenience in the document making.

In this embodiment, the extended package also carries basic information that identifies the document, to identify the type of the document package, and carries identifier information about the parent package that needs to be extended. Details are provided in description of composition and making of the document package below.

To facilitate understanding on the foregoing embodiments provided in the present invention, the following describes the composition, making, and presentation of each type of document package in the embodiments of the present invention.

To adapt to the making, management, and updating of documents of multiple products, versions, network management systems, and network elements of one set of devices in the telecommunication field, the embodiments in the present invention provides an updating method applicable to the devices in the telecommunication field. This method may classify document packages into a basic document package, an extended document package, and an update document package, so that the making, management, and updating of the documents may be based on the three document package types. Each type of document package may be the document package made through combination of multiple files. For example, files in the XML, HtmlHelp, JavaHelp, Office, and Pdf formats may be combined and made to form a document package. Each document package may include the following content: (1) Basic information used to identify the document, for example, product model, product version, document version, document package type, and document package identifier. When the document package is the extended package, destination node information that identifies a mounting location may also be included. When the document package is the patch package, patch package information, such as a parent package identifier may be included, to identify the parent package applicable to the patch package. (2) Navigation information for navigation presentation, which may include navigation nodes, with each navigation node having a node universal resource locator (Universal Resource Locator, URL) that is used to direct to an associated file, where each file has one unique identifier, so that each navigation node may associate with a file through the unique identifier. (3) Index information for search, which may be used for quick search. The index may be made targeted at presentation content during the making of the document package. (4) File information for presentation, which is the file used for making the document package. The file is associated with the corresponding navigation node through the node URL. (5) Abstract information that records the navigation node, for example message digest algorithm 5 MD5 file, to determine whether the node and its associated file are modified. The document package may also include other support files. The following describes the making and application of each type of document package respectively.

1. Basic Document Package

The basic document package is a completely independent document package and may be presented independently, not depending on another document package. The making process is as follows:

Firstly, generate navigation, index, and a node resource file according to a source file.

Then, make a document package by using the source file, navigation, index, and node resource file.

When the basic document package is used, each navigation node and its associated source file may be presented to the users according to the navigation information. To be specific, the navigation information is presented to the users in a tree shaped manner, so that the users may view the source file associated with the navigation node by selecting each navigation node in the tree.

2. Extended Package

The extended package is the document package that may be mounted to the basic package or another extended package, and the extended package may exist and be presented as an independent document package, where the mounted basic package or another extended package may become the parent package. The making process is as follows:

Firstly, generate, according to the extended file, the navigation, index, and a node resource file and a destination node of the parent package to be extended.

Then, make a document package by using the extended file, navigation, index, node resource file, and destination node.

In addition, priority of a mounted current package may be selected according to attribute of the mounted parent package. In this manner, when there are two extended packages for the same mounting location, the extended package with the higher priority may be mounted in the front and displayed in the front.

When the extended package is used, the extended package may be integrated to the parent package according to the destination node and be presented together with the parent package. Furthermore, the extended package may also be presented as the independent document package and the detailed presentation manner of the extended package is the same as that of the basic package.

3. Patch Package

The patch package only contains changed content between the updated document and the document before the updating. The basic package, extended package, or another patch package may be updated to form a new basic package, extended package, or patch package, where the basic package, extended package, or another patch package used for the updating may also become the parent package. The making process is as follows:

Firstly, compare a patch file in the patch package with a node abstract file in the parent package, and record modification information, including information of newly added, information of modified, and information of deleted, to the node resource file of the patch package according to a comparison result to form the node resource file of the patch package.

Then, integrate the node resource file of the patch package into the patch package and integrate the newly added modified source file into the patch package.

Finally, make the index of the newly added modification and integrate the index into the patch package to form the patch package that may be used for updating. The patch package also includes patch information.

When the patch package is used, the patch package may be advertised to a document package to be updated to update the parent package.

In this embodiment, each document package may be composed of files of different formats and the navigation node in the document package is associated with the combined file respectively. In this manner, when the document is updated, only the navigation information in the document package to be updated needs to be updated, making the document updating convenient. Furthermore, the making of each update document package is very convenient, which facilitates the making and uploading of the update document package and improves convenience in the document updating, and is especially applicable to the making, management, and updating of a large document.

In this embodiment, through classifying the document packages into the basic package, extended package, and patch package, the documents may be advertised with target according to different networking manners of telecommunications devices. The following illustrates advertisement manners of different document combinations.

1. Basic Package and Patch Package

For a product document which has relatively little document content and products of a single type, which may be completed independently by one person, the product document may be advertised in the format of the basic package and patch package. In this manner, an initially compiled document may be made as an independent basic package and advertised. In the case of a few later changes and modifications, the formats of the patch package to the basic package and the patch package to the patch package may be used for advertisement, where the patch package only contains added parts, thereby occupying small disk space and easy for downloading, and the updating of the basic package is very convenient.

2. Basic Package and Extended Package

Targeted at the case where a product has a network management system and a network element, the model of the basic package and the extended package of the basic package may be used for support. For example, a network management document may be included in the basic package, while each extended package belongs to an independent network element document, mounting to a destination location of a main navigation. When the document is advertised, it is advertised in the format of the basic package and multiple extended packages, where the basic package may be assigned to a network management device and the extended packages may be assigned to corresponding network element devices. In this manner, the network element device may be dynamically added and deleted. An effective document may be made for users. A user may view only online help about a network element device the user is using and may not view the document about one or more other network elements or network management devices, avoiding interference by an irrelevant document. Meanwhile, the documents of the network management device exist separately from those of the network element device, and the network management system or network element needs only to maintain its own documents without the need to combine each version for advertisement in a case that an interface for the network management system or network element remains unchanged. During the document updating, only the network management document or the network element document that needs the updating needs to be updated, which makes the document updating extremely convenient.

3. Basic Package, Extended Package, and Patch Package

For the document that needs frequent patch updating, the document may be advertised by adopting the manner of basic package, extended package, and extended package, where the basic package corresponds to the network management device and the extended package corresponds to the network element device. When the patch updating is needed, the patch packages may be made separately for different network element documents or network management documents, and delivered to corresponding network elements or network management systems to implement the patch updating on the document. In this manner, document updating for each network element or network management system does not affect the document of one or more other network elements or network management systems, effectively decreasing coupling of the network management document and network element document. A patch is relatively small, which facilitates downloading and updating by users.

It may be seen that, through classifying the document packages into the basic package, patch package, and extended package, modular making may be performed on the document as needed during product developing of telecommunications devices. In this manner, the document needed by a corresponding product may be advertised to the corresponding product, while not every product needs to include the documents of the entire device. During the document making, through narrowing development scope and maintenance scope and allowing the document of the same module to be shared by multiple products, the development, maintenance, and updating costs of the document are lowered; through allowing a document module to be dynamically added and deleted, different customized delivery is implemented; through allowing the document module to be dynamically added and deleted, minimize dynamic adding and deleting of the document when a customer adding and deleting function is implemented; the patch is made based on the module, which minimizes patch scope and avoids resource waste caused by replacement of a large document.

A person skilled in the art may understand that the method for document updating provided in this embodiment may apply to the updating of documents in the telecommunication field and also apply to the updating of other documents that need similar updating, which is not limited here.

FIG. 5 is a schematic structural diagram of an apparatus for document updating provided by Embodiment 5 of the present invention. As shown in FIG. 5, the apparatus in this embodiment includes an update document obtaining module 1 and a document updating module 2, where:

the update document obtaining module 1 is configured to obtain an update document package, where the update document package includes update navigation information and an update file, where each navigation node in the update navigation information is associated with a corresponding update file respectively;

the document updating module 2 is configured to according to the update navigation information and source navigation information of a source document package, integrate the update document package into the source document package to update the source document package, where the source document package includes the update navigation information and a source file, where each navigation node in the update navigation information is associated with a corresponding source file respectively.

The embodiment in the present invention may apply to document updating to implement updating of a document. For its detailed implementation process, reference may be made to description of the foregoing embodiment in the present invention, and details are not described here again.

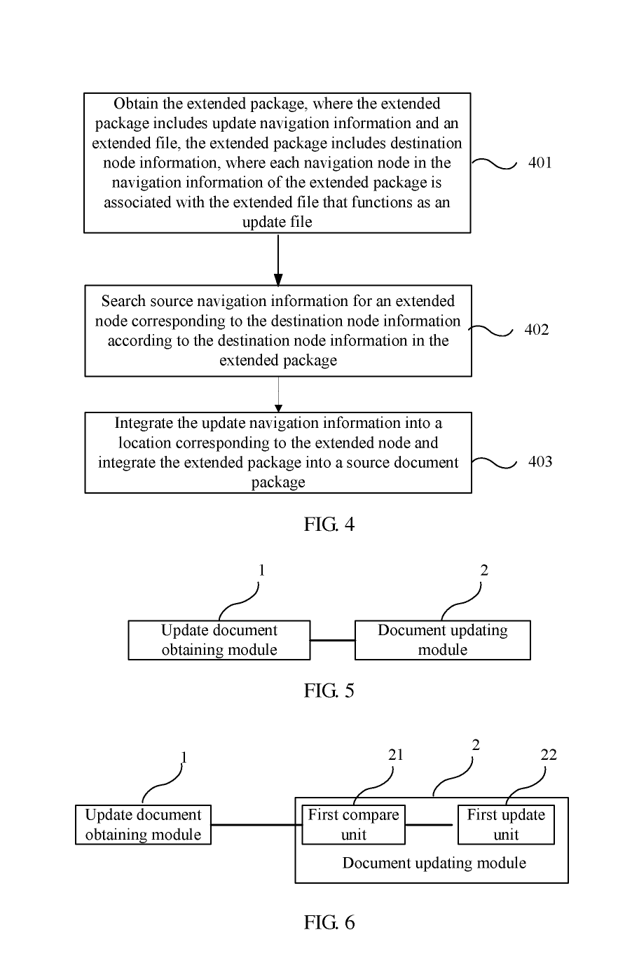

FIG. 6 is a schematic structural diagram of an apparatus for document updating provided by Embodiment 6 of the present invention. As shown in FIG. 6, an update document package obtained by an update document obtaining module 1 in this embodiment is a patch package, and a navigation node in the patch package that differs from the navigation node in a source document package is associated with a patch file that functions as an update file; a document updating module 2 may include a first compare unit 21 and a first update unit 22, where:

the first compare unit 21 is configured to compare source navigation information with update navigation information to obtain added, deleted, and modified navigation nodes in the update navigation information relative to the source navigation information;

the first update unit 22 is configured to delete the deleted and modified navigation nodes from the source navigation information and add, to the source navigation information, the navigation nodes that are added and modified in the update navigation information, to implement updating of the source document package.

This embodiment may implement patch updating on a document based on a patch package format. For its detailed implementation manner, reference may be made to description of Embodiment 2 in the present invention method, and details are not described here again.

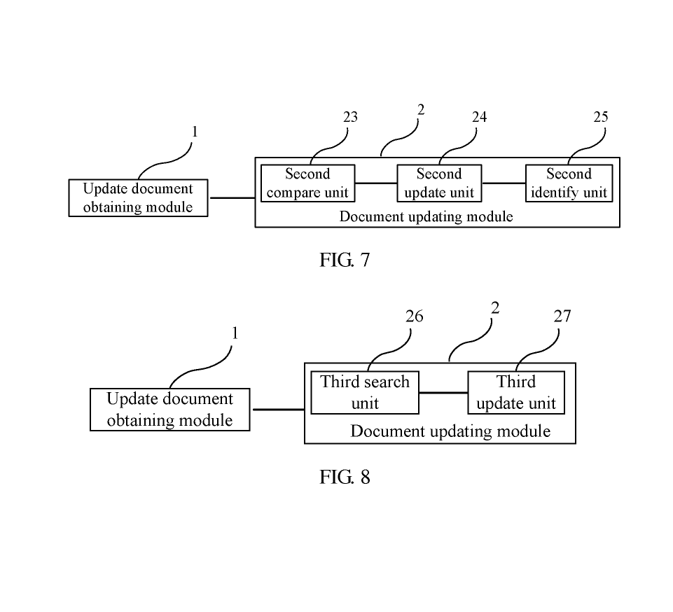

FIG. 7 is a schematic structural diagram of an apparatus for document updating provided by Embodiment 7 of the present invention. Different from the technical solution provided by an embodiment shown in the foregoing FIG. 6, in this embodiment, when a patch file is integrated to a source document package, modifications to a modifiable document are distinguished, so that users may conveniently know the modifications made to a parent package. Specifically, as shown in FIG. 7, a document update module 2 in this embodiment apparatus may include a second compare unit 23, a second update unit 24, and a second identify unit 25, where:

the second compare unit 23 is configured to compare source navigation information with update navigation information to obtain added, deleted, and modified navigation nodes in the update navigation information relative to the source navigation information;

the second update unit 24 is configured to add, to the source navigation information, the navigation nodes that are added and modified in the update navigation information to implement updating of the source document package;

the second identify unit 25 is configured to add a new add modify mark to the navigation node added to the updated source navigation information, add a modify mark to a modified navigation node and the corresponding navigation node before the modification, and add a delete modify mark to a deleted navigation node, so that update content may be viewed according to the new add modify mark, modify mark, and delete modify mark.

This embodiment may implement patch updating on a document based on a patch package format and identify the update content in the updated document package. For its detailed implementation manner, reference may be made to description of Embodiment 3 in the present invention method, and details are not described here again.

FIG. 8 is a schematic structural diagram of an apparatus for document updating provided by Embodiment 8 of the present invention. As shown in FIG. 8, an update document package obtained by an update document obtaining module 1 in this embodiment is an extended package and the extended package may include destination node information, where each navigation node in navigation information of the extended package is associated with an extended file that functions as an update file; a document updating module 2 may include a third search unit 26 and a third update unit 27, where:

the third search unit 26, searches source navigation information for an extended node corresponding to the destination node information according to the destination node information in the extended package;

the third update unit 27 integrates update navigation information into a location corresponding to the extended node and integrates the extended package into a source document package.

This embodiment may implement extended updating on a document based on an extended package format. For its detailed implementation manner, reference may be made to description of Embodiment 4 in the present invention method, and details are not described here again.

Persons of ordinary skill in the art may understand that, all or a part of the steps of the methods in the embodiments may be implemented by a program instructing relevant hardware. The foregoing program may be stored in a computer readable storage medium. When the program is run, the steps included in the methods of the embodiments are performed. The foregoing storage medium includes any medium that may store program code, such as a ROM, a RAM, a magnetic disk, or an optical disk.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof; without departing from the spirit and scope of the technical solutions of the embodiments of the present invention.

1. A method for document updating, comprising:
obtaining an update document package, wherein the update document package comprises update navigation information and an update file, wherein each navigation node in the update navigation information is associated with a corresponding update file respectively;
according to the update navigation information and source navigation information of a source document package, integrating the update document package into the source document package to update the source document package, wherein:
the source document package comprises the source navigation information and a source file, wherein each navigation node in the source navigation information is associated with a corresponding source file respectively.

2. The method for document updating according to claim 1, wherein the update document package is a patch package, wherein a navigation node in the patch package that differs from the navigation node in the source document package is associated with a patch file that functions as the update file;
according to the update navigation information and the source navigation information of the source document package, integrating the update document package into the source document package, comprising:
comparing the source navigation information with the update navigation information to obtain added, deleted, and modified navigation nodes in the update navigation information relative to the source navigation information;
deleting the deleted and modified navigation nodes from the source navigation information and adding, to the source navigation information, navigation nodes that are added and modified in the update navigation information, to implement updating of the source document package.

3. The method for document updating according to claim 1, wherein update document package is a patch package, wherein a navigation node in the patch package that differs from the navigation node in the source document package is associated with a patch file that functions as the update file;
the according to the update navigation information and the source navigation information of the source document package, integrating the update document package into the source document package, comprising:
comparing the source navigation information with the update navigation information to obtain added, deleted, and modified navigation nodes in the update navigation information relative to the source navigation information;
adding, to the source navigation information, navigation nodes that are added and modified in the update navigation information, to implement updating of the source document package;
adding a new add modify mark to the navigation node that is added to updated source navigation information, adding a modify mark to a modified navigation node and a corresponding navigation node before modification, and adding a delete modify mark to the deleted navigation node, so that update content may be viewed according to the new add modify mark, modify mark, and delete modify mark.

4. The method for document updating according to claim 2, wherein the patch package further comprises source document package information configured to identify the source document package updated by the patch package;
before the according to the update navigation information and the source navigation information of the source document package, integrating the update document package into the source document package, further comprising:
according to the source document package information in the patch package, determining a source document package that needs to be updated, to use the patch package to update the source document package.

5. The method for document updating according to claim 1, wherein the update document package is an extended package, wherein the extended package comprises destination node information, wherein each navigation node in the navigation information of the extended package is associated with an extended file that functions as the update file;
the according to the update navigation information and the source navigation information of the source document package, integrating the update document package into the source document package, comprising:
searching the source navigation information for an extended node corresponding to the destination node information according to the destination node information in the extended package;
integrating the update navigation information into a location corresponding to the extended node to implement updating of the source document package.

6. An apparatus for document updating, comprising:
an update document obtaining module, configured to obtain an update document package, wherein the update document package comprises update navigation information and an update file, wherein each navigation node in the update navigation information is associated with a corresponding update file respectively; and
a document updating module, configured to: according to the update navigation information and source navigation information of a source document package, integrate the update document package into the source document package to update the source document package, wherein:
the source document package comprises the update navigation information and a source file, wherein each navigation node in the update navigation information is associated with a corresponding source file respectively.

7. The apparatus for document updating according to claim 6, wherein the update document package is a patch package, wherein a navigation node in the patch package that differs from the navigation node in the source document package is associated with a patch file that functions as the update file;
the document updating module comprises:
a first compare unit, configured to compare the source navigation information with the update navigation information to obtain added, deleted, and modified navigation nodes in the update navigation information relative to the source navigation information;
a first update unit, configured to delete the deleted and modified navigation nodes from the source navigation information and add, to the source navigation information, navigation nodes that are added and modified in the update navigation information, to implement updating of the source document package.

8. The apparatus for document updating according to claim 6, wherein the update document package is a patch package, wherein a navigation node in the patch package that differs from the navigation node in the source document package is associated with a patch file that functions as the update file;
the document updating module comprises:
a second compare unit, configured to compare the source navigation information with the update navigation information to obtain added, deleted, and modified navigation nodes in the update navigation information relative to the source navigation information;
a second update unit, configured to add, to the source navigation information, navigation nodes that are added and modified in the update navigation information, to implement updating of the source document package;
a second identify unit, configured to add a new add modify mark to a navigation node that is added to the updated source navigation information, add a modify mark to a modified navigation node and a corresponding navigation node before modification, and add a delete modify mark to a deleted navigation node, so that update content may be viewed according to the new add modify mark, modify mark, and delete modify mark.

9. The method for document updating according to claim 6, wherein the update document package is an extended package, wherein the extended package comprises destination node information, wherein each navigation node in the navigation information of the extended package is associated with an extended file that functions as the update file;
the document updating module comprises:
a third search unit, configured to: search the source navigation information for an extended node corresponding to the destination node information according to the destination node information in the extended package;
a third update unit, configured to integrate the update navigation information to a location corresponding to the extended node to implement updating of the source document package.
